(19) United States
(12) Patent Application Publication
(10) Pub. No.: US 2015/0094412 A1
(43) Pub. Date: Apr. 2, 2015

(54) LATERITE AND POLYMER CONSTRUCTION BRICK AND MATERIAL AND METHOD OF MANUFACTURING SAME

(71) Applicants: Victor Manuel García Alarcón, Cali (CO); Wilson Osorio Rincón, Cali (CO); Ramiro De la Cruz Mesa, Cali (CO); Rafael Ivan Millán Vivas, Cali (CO)

(72) Inventors: Victor Manuel García Alarcón, Cali (CO); Wilson Osorio Rincón, Cali (CO); Ramiro De la Cruz Mesa, Cali (CO); Rafael Ivan Millán Vivas, Cali (CO)

(21) Appl. No.: 14/498,083

(22) Filed: Sep. 26, 2014

Related U.S. Application Data
(60) Provisional application No. 61/883,546, filed on Sep. 27, 2013.

(51) Int. Cl. C04B 26/02; B28B 3/00; B28B 1/14

(52) U.S. Cl. CPC C04B 26/02; B28B 1/14; B28B 3/00
USPC 524/435; 264/333

(57) ABSTRACT

A construction material that can be used in brick form, and method of manufacturing same, comprised of laterites admixed with polymers such as polystyrene, polyethylene and polyvinyl chloride (PVC) and optionally additional elements such as fillers and additives.

### CLAIM OF PRIORITY

This application is being filed as a non-provisional patent application under 35 U.S.C. §111(b) and 37 CFR §1.53(c). This application claims priority under 35 U.S.C. §111(e) to U.S. provisional patent application Ser. No. 61/883,546 filed on Sep. 27, 2013, the contents of which are incorporated herein by reference.

### FIELD OF INVENTION

The present invention relates to construction materials. More particularly, the present invention relates to a construction material that can be used in brick form, and method of manufacturing same, comprised of laterites admixed with polymers such as polystyrene, polyethylene and polyvinyl chloride (PVC). The present invention further permits the admixing of additional elements such as fillers and additives.

### BACKGROUND OF THE INVENTION

Laterites are soil types rich in iron and aluminum which are abundant in many hot and tropical areas around the world. Laterites are easily recyclable, inexpensive, and, when combined with polymers in the manner disclosed in the present invention, form the basis of an ideal construction material (herein referenced as TECNOLATER) which can be used in brick form (herein referenced as EZBRICK).

### SUMMARY OF THE INVENTION

An objective of the present invention is to provide a useful material that can be fabricated at a low cost, because it is fabricated using raw materials such as polymers that are abundant waste and which are recyclable for this purpose, and laterite. Laterite is in very large supply and a naturally occurring material. The material obtained by the fused combination of these two components is highly resistant to other substances, such as acids and alkalis, and has excellent properties in terms of resistance.

Fundamentally it is a solution for waste disposal because it ensures ecological recycling of waste materials discarded as garbage and not suitable for other recycling applications. This material has characteristics which make it ideal for use in construction due to its improved properties and its excellent resistance to flammability.

The construction material material of the present invention can be obtained from a process whose steps are outlined below:

a. fabrication and production of a fused mixture of laterite and polymers with optional contribution of other additives or fillers;

b. introduction of the admixed material into a preheated forming mold;

c. exposure of molded material to high pressure;

d. stabilization and cooling of the formed material.

The fundamental strength of the novel material of the present invention is owed to the abundant availability of laterite in nature and the inexpensive nature of its extraction for use. The polymers recycled from waste byproduct of other applications are equally abundant and easy to extract. The use of naturally occurring laterite and inexpensive recycled waste polymers makes it unnecessary to use higher quality, and more expensive, virgin materials.

The construction material obtained from the described compaction processes is dimensionally stable and susceptible to a variety of high quality finishes. The resulting material has a homogeneous structure that makes it resistant to high mechanical loads. Given their nature, polymers create a network or matrix which surrounds the laterite and the other components giving the material high durability and excellent wear resistance.

The resulting material has superior characteristics such as:
resistance to breakage and impact as a result of the energy-absorbing qualities of polymers;
excellent resistance to abrasive wear;
good machinability in the processes of drilling, sawing and turning;
excellent barrier properties due to low water absorption.
excellent resistance to chemical attack by acids and alkalis.
excellent resistance to transmission of electrical current (electrical insulator).
excellent resistance to heat conduction (thermal insulation).
can be recycled and reused as raw material.
compactable with cement concrete, additives, colorants, glass, and wood;
excellent resistance to flammability and self-extinguishing characteristics.

The main field for the application of the described material is in construction given the variety of shapes that can be obtained by molding. The material can also be applied in other fields due to other beneficial qualities such as electrical insulation, thermal insulation and waterproofing.

The process of creating the fused mixture of laterite, polymers and aggregates in the material of the present invention is detailed in the following steps:

a. introduction of laterite into a vessel where it is pulverized and dehydrated at a temperature of approximately 200-300, but preferably 250 degrees Celsius;

b. transfer of the dehydrated and pulverized heated laterite into a pre-heated mixing device;

c. introduction of measured and powdered polymers into the mixing device; and

d. mixing of laterite and polymers, and optionally additives and aggregates, under controlled heating until reaching the melting temperature of the polymers involved in the formulation.

The material composition of the present invention comprises at least 50 to 60% laterite and 15 to 30% of polymer relative to the total mass, depending on the desired characteristics in terms of plasticity, strength and finish that is intended. The remaining percentage is for aggregates, dyes or fillers.

The high moldability of the resulting material permits the use of forming molds with intricate shapes that allow for near-perfect mechanical anchoring of the resulting brick. These characteristics are utilized for the design and dimensioning of the structural brick that is the subject object of the present invention.

The geometry of the brick itself allows for sizing in standard measures and facilitates construction work of walls and other structures. The nature of EZBRICK, optimized for mechanical anchorage, minimizes the use of elements such as cement paste and mortar.

Thanks to the nature of TECNOLATER, which is characterized by high compressive strength and retention without showing deformation, the EZBRICK allows for the transfer of large loads, which makes it highly suitable for construction applications and competitive with other construction materials.

### BRIEF DESCRIPTION OF THE DRAWINGS

FIG. 1 illustrates a simple-shaped brick that is possible using brick compositions known in the prior art.

FIG. 2 illustrates an isometric view of a complex-shaped brick that is made possible by using the compositions and methods of the present invention.

FIG. 3 illustrates side and front cross-sectional view of a complex-shaped brick that is made possible by using the compositions and methods of the present invention.

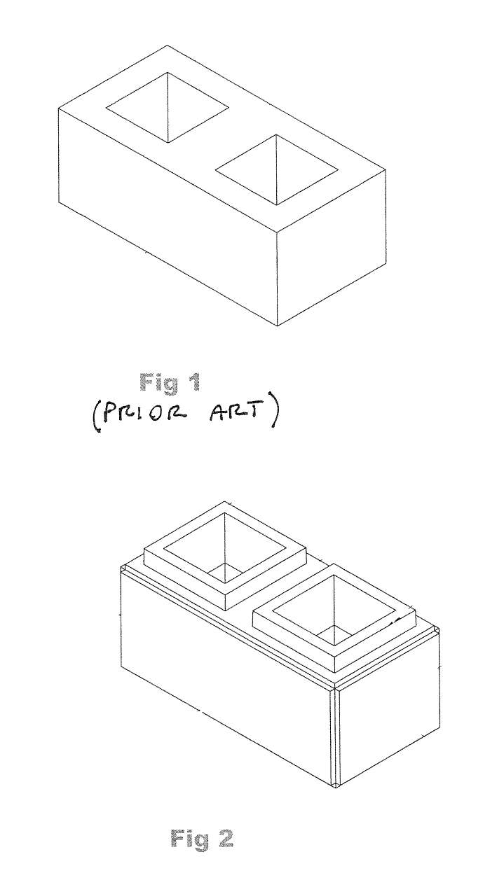

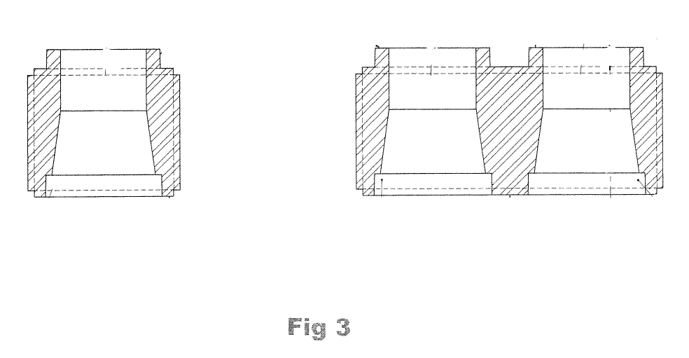

### DETAILED DESCRIPTION OF THE INVENTION

One example of the final composition of the above described material has 76.4% laterite as a main component and as a secondary component 23.6% polymer made from a mixture of polystyrene, PVC and polyethylene.

Laterite during manufacture is heated to 250 degrees Celsius. Then the polymers are poured into the mixer in a gradual manner, first PVC, next polyethylene and then finally polystyrene. The polymers are ideally in powder form in a particle size between 0.5 and 0.8 mm. The polymers can be obtained in virgin form but can also be obtained from waste byproducts.

The mixture is brought to a temperature slightly above the melting point of the polymers used, after which it is deposited onto a forming mold preheated to approximately 150 degrees Celsius and between 1500 and 2000 psi of pressure is applied. It is noteworthy that at higher pressures more specific properties may be achieved in the products to be manufactured.

The mixture is then allowed to cool and set after which it can be removed from the mold as a brick.

After production using the above steps, the following properties can be observed in the typical TECNOLATER material sample:
Compressive strength of 521 kg/cm2
Modulus of rupture of 110 Kg./cm2
Water absorption after 24 hours 2.9%
Acid resistance 96%
Surface is smooth, semi-gloss
Reddish tint given by the natural color of laterite

Variations can be used in the way the process is carried out as to the introduction sequence and mixing of the materials.

A first variation is to perform a very thorough mechanical mixture of the dried and pulverized laterite with polymers and additives or fillers at room temperature. Then gradually increasing the temperature of the mixer while continuing the mixing process until reaching the melting point of the polymers. This point can vary between 90 and 350 degrees Celsius. Said point tends to vary depending on the nature of the polymers used. Clearly it is more convenient to use polymers whose melting points are low to minimize energy expenditure involved heating to reach these melting points.

A second variation is to utilize laterite dried and pulverized at a temperature between 200 and 350 degrees Celsius. The value to be achieved depends on the polymers used in the formulation. Then adding the required amount of polymer chosen and any additives or fillers to be gradually mixed with hot laterite. A variant of the process comprises mixing in reverse, i.e. adding hot laterite gradually to the polymers and additives in the mixer. In this form of the process, the temperature of the laterite descends, while the temperature of the polymers increases. The result is obtaining a mixture at a temperature lower than the original temperature of the laterite. The specification to control is the final temperature, winch should be slightly higher than the melting point of the polymers.

A third variation is to bring the polymer or polymer mixture to a temperature close to the melting point and then add them to the laterite within the mixer preheated to a temperature of 250 degrees Celsius.

Either variant of the process results in a mixture of polymers laterite and other optional additives and aggregates which is homogeneous in nature with plastic condition properties.

Although described above in connection with specific embodiments, various modifications and structural changes may be made to the disclosed invention without departing from the spirit of the invention and within the scope and range of equivalents of the following claims.

We claim:

1. A method for manufacturing a brick composed of a fused mixture of laterite, polymers and aggregates comprising the steps of:
a. introducing laterite into a vessel where it is pulverized and dehydrated at a temperature of approximately 250 degrees Celsius;
b. transfering said dehydrated and pulverized heated laterite into a heated mixing device;
c. introducing powdered polymers into said heated mixing device;
d. mixing said laterite and said polymers under controlled heating until reaching the melting temperature of said polymers;
e. pouring the resulting mixture into a brick mold and applying pressure of approximately 1500 psi until it is cooled and cured.

2. A brick prepared by a process comprising the steps of:
a. introducing laterite into a vessel where it is pulverized and dehydrated at a temperature of approximately 250 degrees Celsius;
b. transfering said dehydrated and pulverized heated laterite into a heated mixing device;
c. introducing powdered polymers into said heated mixing device;
d. mixing said laterite and said polymers under controlled heating until reaching the melting temperature of said polymers;
e. pouring the resulting mixture into a brick mold and applying pressure of approximately 1500 psi until it is cooled and cured.
f. removing said brick from said brick mold.
